(19) United States
(12) Patent Application Publication
(10) Pub. No.: US 2022/0203648 A1
(43) Pub. Date: Jun. 30, 2022

(54) DEVICE FOR HOLDING A VEHICLE BODY PART TO BE MEASURED IN A REFERENCE POSITION

(71) Applicant: CARL ZEISS FIXTURE SYSTEMS GMBH, Tholey (DE)

(72) Inventor: Stephan KIRSCH, Riegelsberg (DE)

(21) Appl. No.: 17/604,110

(22) PCT Filed: Mar. 16, 2020
(86) PCT No.: PCT/DE2020/100195

§ 371 Date: Oct. 15, 2021

(30) Foreign Application Priority Data
Apr. 23, 2019 (DE) 10 2019 110 464.5

(51) Int. Cl. B32B 3/12; B32B 7/12

(52) U.S. Cl. CPC B32B 3/12; B32B 2305/024; B32B 7/12

(57) ABSTRACT

A device for holding a vehicle body part to be measured and/or a measuring machine for measuring such a vehicle body part in a reference position, having a baseplate, which includes a layer with a honeycomb structure and at least one outer layer designed to receive holding elements. Lugs, which end in a common plane and bear against the outer layer, protrude from the layer having the honeycomb structure in a manner distributed over the plate surface of the baseplate.

The invention relates to an apparatus for holding a vehicle body component to be measured or/and for holding a measuring machine for measuring such a component in a reference position, having a base plate which comprises a layer with a honeycomb structure and at least one outer layer designed to receive holding elements.

DE 10 2017 108 671 A1 discloses such a holding apparatus having a base plate, of which the layer having the honeycomb structure is adhesively bonded as intermediate layer on both sides to outer layers of aluminum.

Disadvantageously, the large-area adhesive bonding of the outer layers to the intermediate layer under press pressure leads to deformation of the outer layers previously fabricated with high precision.

The present invention creates a new holding apparatus of the aforementioned type, which is characterized in that lugs which end in a common plane and bear against the outer layer protrude from the layer having the honeycomb structure in a manner distributed over the plate surface of the base plate.

According to the invention, the layer having the lugs forms an exactly fabricated receiving base, to which exactly prefabricated outer layers can be connected without deformation.

Preferably, the layer having the honeycomb structure forms an intermediate layer, from which lugs which end in mutually parallel planes and each bear against an outer layer protrude on both sides. Advantageously, on such a base plate, vehicle body components which have a mirror image relative to one another, in particular a right-hand and left-hand vehicle body side wall, can be held simultaneously on opposite sides of the base plate in a symmetrical arrangement.

Expediently, the lugs comprise plates connected to the intermediate layer, in particular adhesively bonded to the intermediate layer.

During the production of the base plate, end surfaces of the lugs that face away from the layer or intermediate layer, that is to say, for example, the plate surfaces that face away from the layer or intermediate layer, are machined mechanically, preferably milled, in such a way that all the plate surfaces lie in one and the same plane and the plane of the lugs of one side is parallel to the plane of the lugs of the other side of the base plate.

Expediently, the lugs protruding from the intermediate plate on both sides are arranged to coincide from plate side to plate side.

Preferably, the lugs are distributed in a grid arrangement over the plate surface of the base plate.

In a further preferred embodiment of the invention, the layer or intermediate layer has insert pieces with devices for screwing or/and pinning to the outer layer.

Expediently, the insert pieces are each aligned with one of the projecting lugs and in particular arranged concentrically with respect to the lugs.

The insert pieces expediently extend continuously over the thickness of the intermediate layer, so that they can be used on both sides for screwing or/and pinning to an outer layers.

The invention will be explained in more detail below on the basis of an exemplary embodiment with reference to accompanying drawings which relate to this exemplary embodiment and in which:

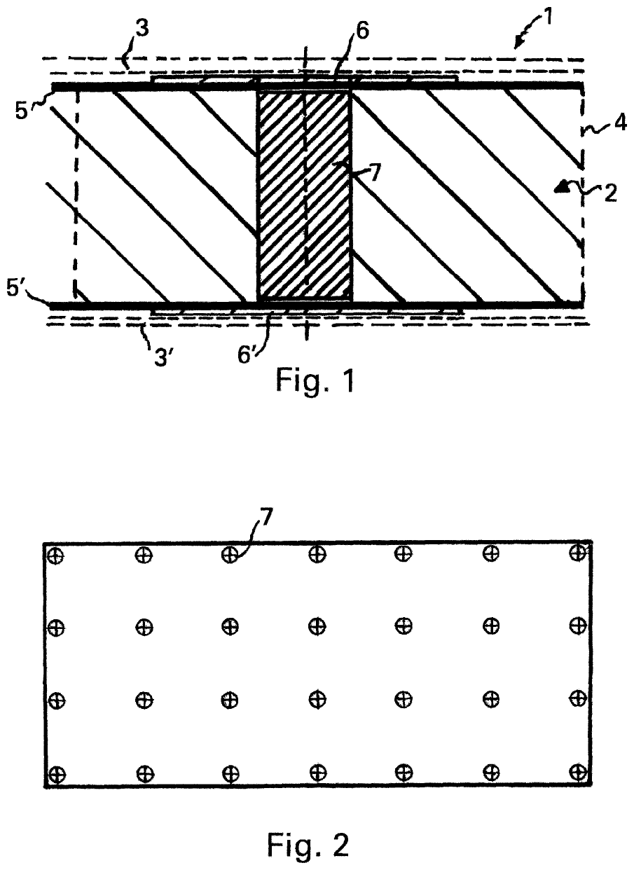

FIG. 1 shows a sectioned partial illustration of a base plate of a holding apparatus according to the invention,

FIG. 2 shows an intermediate layer of the base plate from FIG. 1 in a plan view.

An apparatus for holding a vehicle body component to be measured (not shown) in a reference position comprises a base plate 1, illustrated in the form of a detail in FIG. 1, to which further apparatus parts, in particular holding elements, can be attached.

The base plate 1 comprises an intermediate layer 2, on the plate sides of which a respective outer layer 3 and 3′ for receiving the further apparatus parts is arranged.

The intermediate layer 2 consists of a honeycomb core 4, which is adhesively bonded on both sides to a covering plate 5 and 5′. In the example shown, the thickness of the honeycomb core is 140 mm, the thickness of the covering plates is in each case 2 mm. The honeycomb structure has honeycomb chambers which extend continuously over the entire thickness of the honeycomb core 4 and which are each closed by the covering plates 5, 5′.

As FIG. 1 shows by way of example, between the intermediate layer 2 and the outer layers 3, 3′ there are in each case lugs 6 and 6′ which form spacer elements and protrude from the intermediate layer 2. The lugs 6, 6′, formed by circular plates in the example shown, are arranged to be distributed over the plate surface of the base plate 1 and are each adhesively bonded to the covering plate 5 and 5′.

Extending concentrically with respect to the lugs 6, 6′ through the intermediate layer 2 are insert pieces 7 with threaded bores (not shown) which extend through the lugs 6, 6′ and which are open toward the plate surface of the lugs 6, 6′ that faces away from the intermediate layer 2.

The threaded bores allow the outer layers 2, 2′ to be screwed to the intermediate layer 3, wherein the end surface of the lugs 6, 6′ that faces away from the intermediate layers 2 bears against the outer layer 3 and 3′.

As can be seen from FIG. 2, the insert pieces 7 having the threaded bores are distributed over the surface of the base plate so as to correspond to a grid arrangement.

In the example described, all of the parts mentioned above, including the honeycomb core 4, consist of aluminum.

During the production of the base plate 1, the lugs 6, 6′, which are adhesively bonded to the covering plates 5, 5′ and which are arranged so as to correspond to the grid arrangement shown in FIG. 2, are milled so that the end surfaces thereof facing away from the intermediate layer 2 each lie in a common plane and wherein the common planes are parallel to one another.

Advantageously, this measure has the effect that a base core is formed which can receive the outer layers 3, 3′ without deformation.

1-10. (canceled)

11. An apparatus for holding a vehicle body component to be measured or/and holding a measuring machine for measuring such a vehicle body component in a reference position, comprising: a base plate having a layer with a honeycomb structure and at least one outer layer designed to receive holding elements; and lugs that end in a common plane and bear against the outer layer protrude from the layer having the honeycomb structure in a manner distributed over a plate surface of the base plate.

12. The apparatus according to claim 11, wherein the layer having the honeycomb structure is an intermediate layer, from which the lugs, which end in mutually parallel planes and each bear against an outer layer, protrude on both sides.

13. The apparatus according to claim 11, wherein the lugs comprise plates connected to the layer.

14. The apparatus according to claim 13, wherein the plates are adhesively bonded to the layer.

15. The apparatus according to claim 11, wherein end surfaces of the lugs that face away from the layer or intermediate layer are machined mechanically.

16. The apparatus according to claim 11, wherein the end surfaces are milled.

17. The apparatus according to claim 12, wherein lugs protrude from the intermediate layer on both sides in a mutually coinciding arrangement.

18. The apparatus according to claim 11, wherein the lugs are distributed in a grid arrangement over the plate surface of the base plate.

19. The apparatus according to claim 11, wherein the layer has insert pieces with a device for screwing or/and pinning to the outer layer.

20. The apparatus according to claim 19, wherein the insert pieces are each aligned with one of the protruding lugs.

21. The apparatus according to claim 20, wherein the insert pieces are each arranged concentrically with respect to the lugs.

22. The apparatus according to claim 19, wherein the insert pieces extend continuously over the thickness of the layer or intermediate layer.
